(19) United States
(12) Patent Application Publication
(10) Pub. No.: US 2024/0001185 A1
(43) Pub. Date: Jan. 4, 2024

(54) AUTOMATIC FIRE EXTINGUISHING SYSTEM

(71) Applicant: Kronebusch Industries, LLC, Rochester, MN (US)

(72) Inventor: Lisa M. Anderson, Owatonna, MN (US)

(73) Assignee: Kronebusch Industries, LLC, Rochester, MN (US)

(21) Appl. No.: 17/855,464

(22) Filed: Jun. 30, 2022

(51) Int. Cl. A62C 37/40; G08B 17/00

(52) U.S. Cl. CPC A62C 37/40; G08B 17/00; A62C 3/07

(57) ABSTRACT

An automatic fire extinguishing system includes an automatic control unit and one or more fire protection units. The automatic control unit monitors one or more protected zones associated with the fire protection units, and automatically activates one or more agent dispensers when a fire is detected.

### BACKGROUND

Fire extinguishers are sometimes used to extinguish or control small fires in emergencies. A fire extinguisher typically includes a cylindrical pressure vessel containing an agent in a pressurized state. The agent can be discharged from the vessel and into the fire to extinguish the fire. Fire extinguishers are often manual handheld devices sized to be handled by a user, which are configured to be activated by the user for use in extinguishing the fire.

Fires sometimes occur when a person is not present, or when a fire extinguisher is not readily available. Further, fires can start unexpectedly, and grow rapidly if they are not promptly put out. Manual fire extinguishers may not be available or activated quickly enough to prevent the fire from causing significant damage.

### SUMMARY

In general terms, this disclosure is directed to an automatic fire extinguishing system. In some embodiments, and by non-limiting example, the automatic fire extinguishing system includes an automatic control unit that monitors one or more protected zones, and activates one or more agent dispensers.

One aspect is a fire extinguishing system comprising: a fire protection unit comprising: a monitoring system for monitoring an environmental status; and an agent dispenser including an aerosol agent container storing aerosol fire extinguishing agent; and an automatic control unit comprising a processor and a memory device, the memory device storing data instructions that, when executed by the processor cause the automatic control unit to: receive the environmental status from the monitoring system; and automatically activate the agent dispenser unit to dispense the fire extinguishing agent when the environmental status indicates the presence of a fire.

Another aspect is an automatic control unit for a fire extinguishing system, the automatic control unit comprising: a processing device; and a memory device storing data instructions that, when executed by the processor cause the automatic control unit to: receive an environmental status from a monitoring system; and automatically activate an agent dispenser unit to dispense an aerosol fire extinguishing agent when the environmental status indicates the presence of a fire.

A further aspect is a method of extinguishing a fire, the method comprising: receiving an environmental status of a protected region at an automatic control unit of a fire extinguishing system; determining that a fire is in the protected region using a processing device of the automatic control unit based on the environmental status; and automatically activating the agent dispense unit from the automatic control unit to cause the agent dispense unit to dispense fire extinguishing agent from a pre-pressurized agent container.

### BRIEF DESCRIPTION OF THE DRAWINGS

FIG. 1 is a schematic block diagram illustrating an example fire extinguishing system.

FIG. 2 is a schematic side view of an example implementation of the fire extinguishing system on a farm implement.

FIG. 3 is another schematic side view of the farm implement with certain regions shown in cutaway to reveal internal compartments.

FIG. 4 illustrates an interior of a cab region of the farm implement shown in FIG. 2 including an automatic control unit of the fire extinguishing system.

FIG. 5 is a schematic block diagram illustrating an example of the automatic control unit components.

FIG. 6 illustrates an example front panel of the automatic control unit.

FIG. 7 illustrates an example of a back panel of the automatic control unit.

FIG. 8 is a schematic block diagram illustrating an example fire protection unit of the fire extinguishing system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

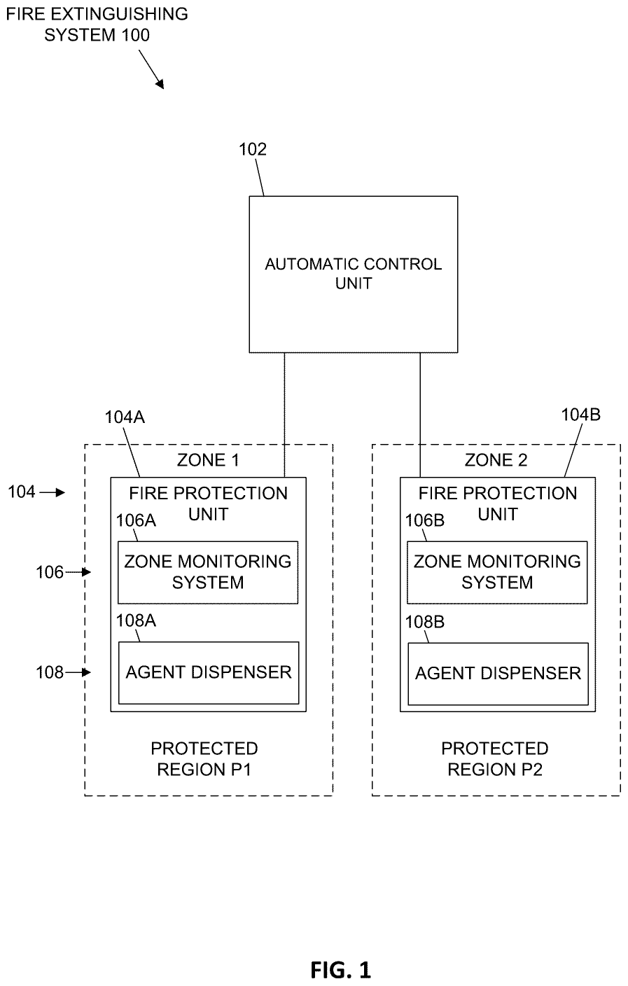

FIG. 1 is a schematic block diagram illustrating an example fire extinguishing system 100. In this example, the fire extinguishing system 100 includes an automatic control unit 102 and one or more fire protection units 104 (104A, 104B). The example fire protection units 104 include a zone monitoring system 106 (106A, 106B) and an agent dispenser 108 (108A, 108B). Also shown is an area that is protected by the fire extinguishing system 100, which includes zones 1 and 2, including protected regions P1 and P2.

The fire extinguishing system 100 operates to monitor and protect an area from fires. In some embodiments it does so by monitoring one or more protected regions. When a fire occurs, the fire extinguishing system 100 activates one or more fire protection units to dispense fire extinguishing agent into the fire, to extinguish the fire.

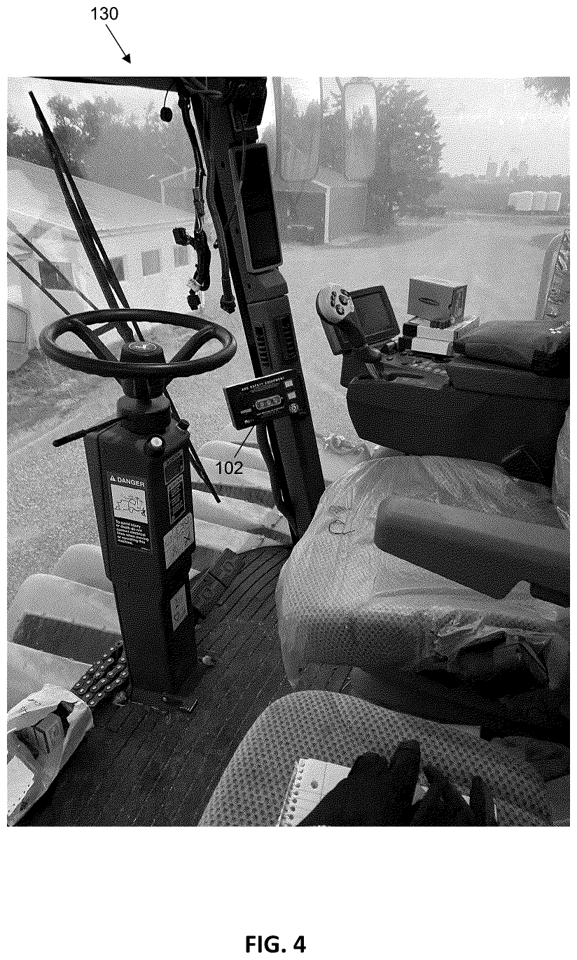

The automatic control unit 102 operates as a centralized controller for the fire extinguishing system 100. In some embodiments the automatic control unit 102 receives status information from the respective zone monitoring systems 106. The automatic control unit 102 monitors the fire protection units 104 as well as the protected regions. The automatic control unit 102 provides status information to the operator regarding the status of the fire extinguishing system 100, and can receive inputs and instructions from the operator. In some configurations, the automatic control unit 102 monitors the status information, and when the status information indicates that a fire has started, the automatic control unit 102 automatically activates one or more of the agent dispensers 108 to rapidly extinguish the fire. In some embodiments the automatic control unit 102 is configured to receive the environmental status from the monitoring system 106, and to automatically activate the agent dispenser 108 to dispense the fire extinguishing agent when the environmental status indicates the presence of a fire. The automatic control unit 102 can also activate the agent dispensers in response to an activation instruction received from the operator. Examples of the automatic control unit 102 are illustrated and described in further detail with reference to FIGS. 4-7.

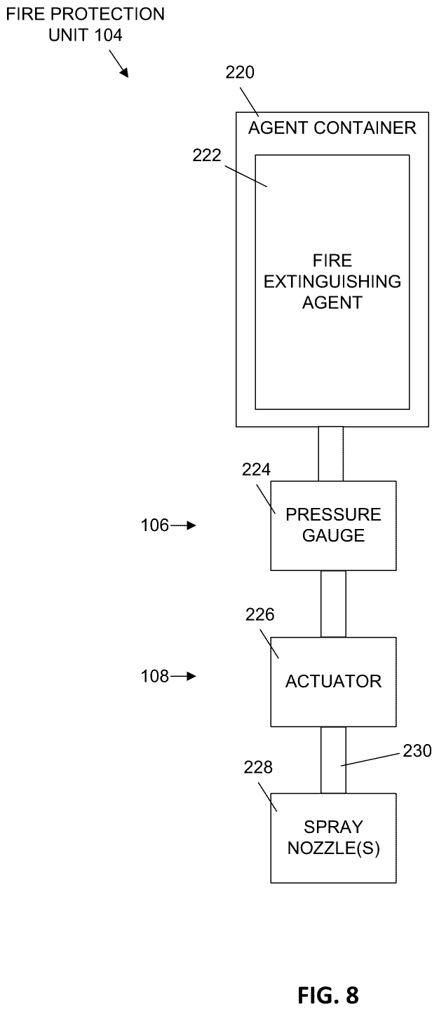

One or more fire protection units 104 are controllable by the automatic control unit. This example illustrates two fire protection units 104A and 104B, but additional fire protection units 104 may be used in other configurations depending on the needs of a particular application. The fire protection units 104 include at least one agent dispenser that stores and selectively dispenses fire extinguishing agent. Some embodiments further include a zone monitoring system 106, which can operate to monitor and send status information regarding the characteristics of the respective zone (including the protected region P1, P2) and/or to monitor and send status information regarding the status of the respective fire protection unit 104. Examples of the fire protection units 104 are illustrated and described in further detail with reference to FIG. 8.

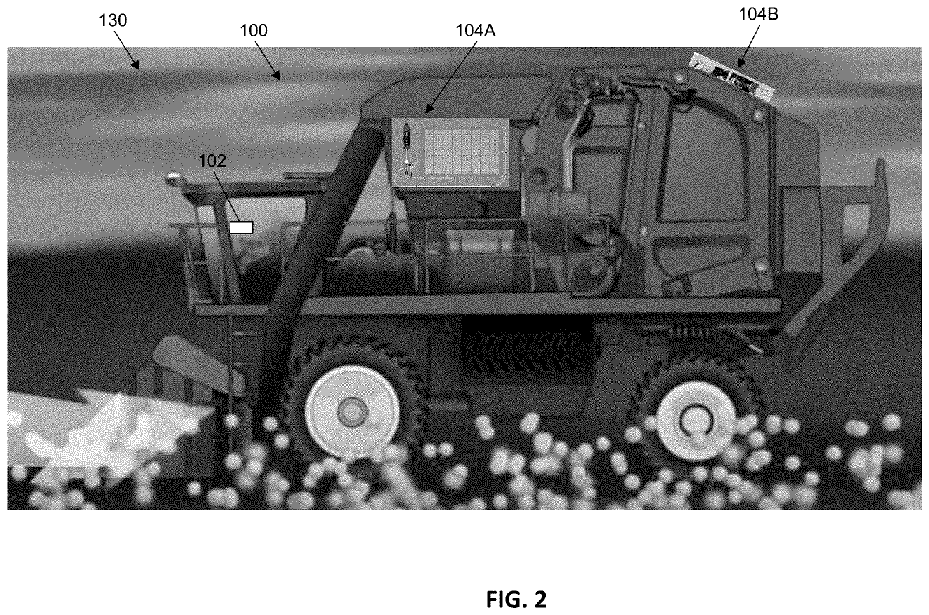

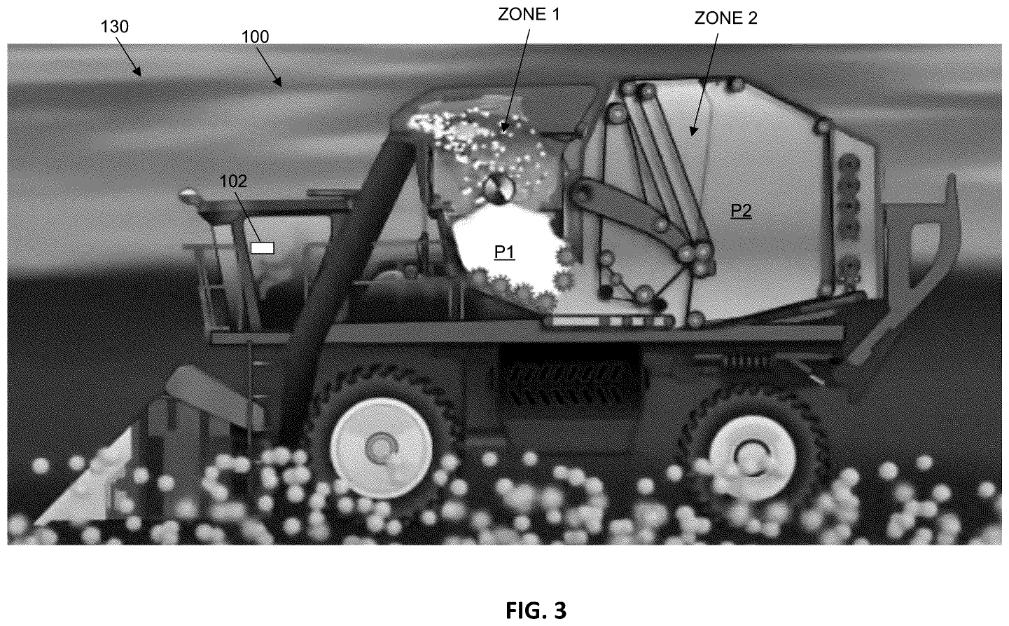

FIGS. 2-3 illustrate one example application of the fire extinguishing system 100 on a mobile vehicle, such as a farm implement 130, and more specifically on an example cotton picker/baler. FIG. 2 is a schematic side view of the farm implement 130, and FIG. 3 is another schematic side view of the farm implement 130 with certain regions shown in cutaway to reveal internal compartments.

The fire extinguishing system 100 can be used in a variety of different applications, such as for protecting stationary physical structures, mobile vehicles, or machinery.

Examples of stationary physical structures include buildings, rooms, work spaces, work sheds, barns (including livestock barns, poultry growout houses, poultry cages, etc.), computer rooms (e.g., server rooms), renewable energy generators (e.g., windmills), and fabrication shops.

Examples of mobile vehicles include cars, trucks, semitrucks, farm implements, mobile forestry equipment, aircraft. Mobile vehicles can be powered by various power sources, such as gas, electric, or hydraulics.

Machinery such as tools, machines, mechanical equipment, conveyor belts, industrial processing equipment, assembly line equipment, welding equipment, lathes, laser equipment, punching or plasma cutting equipment, and forestry equipment.

In the example illustrated in FIGS. 2-3, the fire extinguishing system 100 is part of a mobile vehicle in the form of a farm implement 130. More specifically, the example illustrates an example cotton harvester. The example cotton harvester is a cotton picker. In this example, the cotton picker also includes a baler, such that it is sometimes referred to as a cotton picker/baler.

The example farm implement 130 includes the example fire extinguishing system 100, such as including the automatic control unit 102 and the fire protection units 104 (104A, 104B). The automatic control unit 102 can be located in the cab, where it is in proximity to the operator, for example. The fire protection units 104 are arranged at or adjacent to zones (zones 1 and 2) of the vehicle, associated with protected regions P1 and P2. In this example, the fire protection unit 104A is arranged at zone 1 associated with the accumulator of the cotton picker, such that the protected region P1 is the interior of the accumulator. The fire protection unit 104B is arranged at zone 2 associated with the baler of the cotton picker, such that the protected region P2 is the interior of the baler.

FIG. 4 illustrates an interior of a cab region of the farm implement 130 shown in FIGS. 2-3. The cab region of the farm implement can include a seat, steering wheel, foot pedals or other controls, and the like. In this example, the cab region further includes the automatic control unit 102.

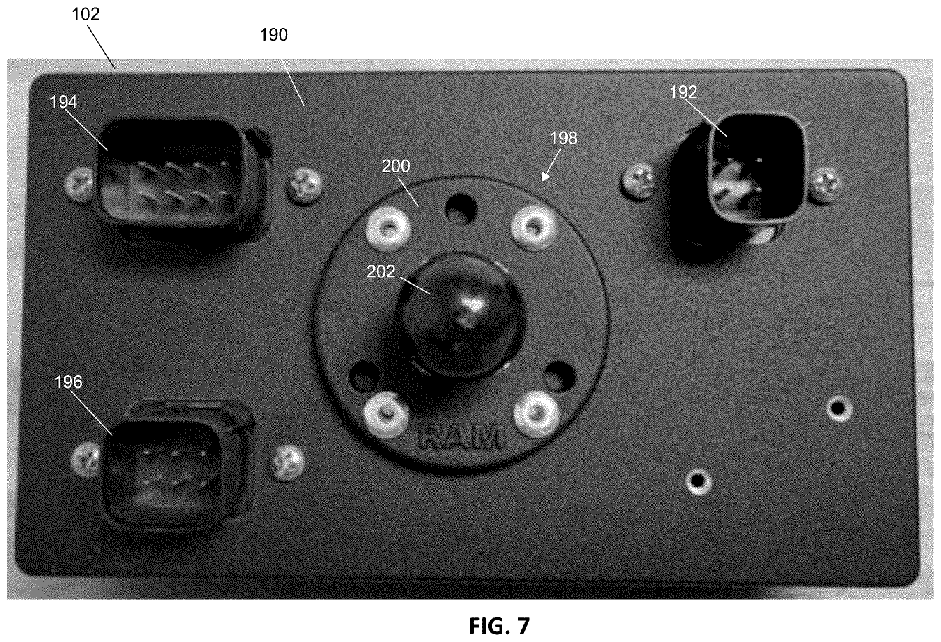

The automatic control unit 102 can be mounted within the cab, such as by fastening the automatic control unit to a frame, wall, or floor using one or more fasteners or mounting components. Examples of mounting components are discussed in further detail with reference to FIG. 7.

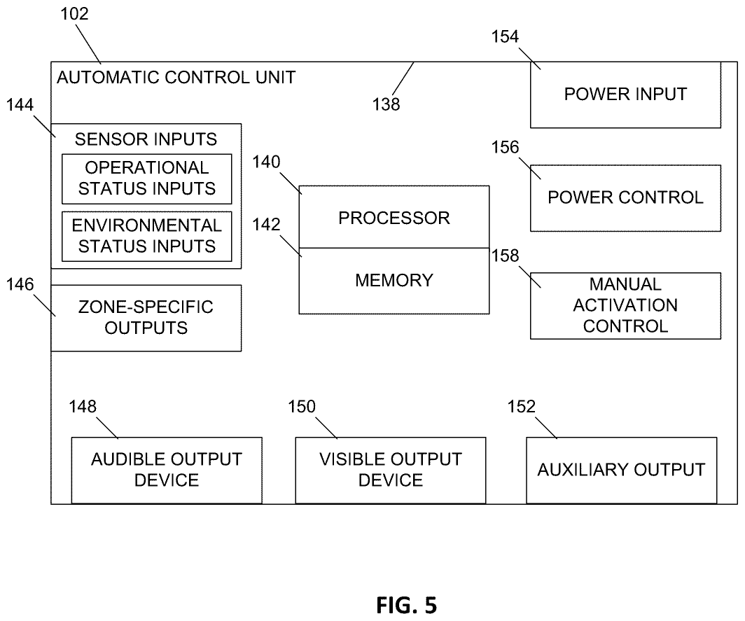

FIG. 5 is a schematic block diagram illustrating an example of the automatic control unit 102 components. In this example, the automatic control unit 102 includes a housing 138, a processor 140, memory 142, sensor inputs 144, zone-specific outputs 146, an audible output device 148, a visible output device 150, an auxiliary output 152, a power input 154, a power control 156, and a manual activation control 158.

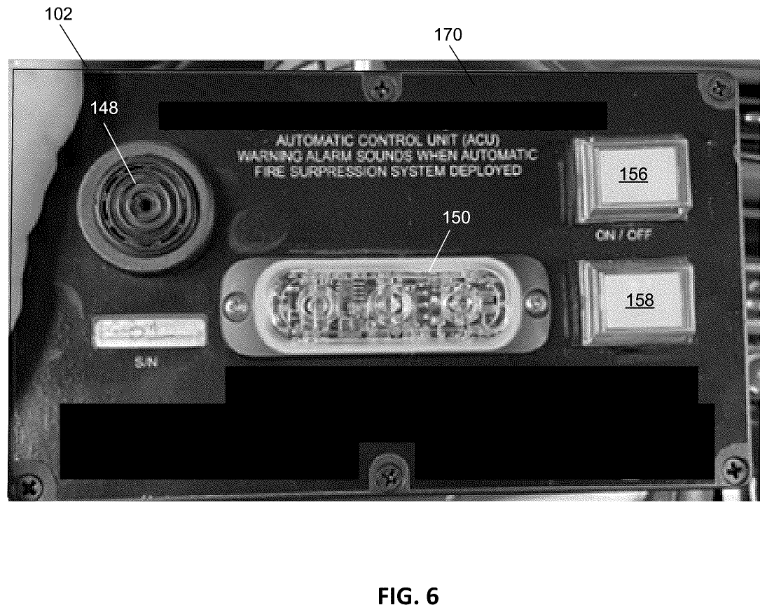

The housing 138 provides a protective enclosure for the automatic control unit, and houses the components therein. In some embodiments the housing is plastic, and has a shape of a box, including a front panel and a back panel. An example of the front panel is shown in FIG. 6 and an example of the back panel is shown in FIG. 7.

The processor 140 performs processing functions for the automatic control unit 102. An example of the processor 140 is a CPU. The processor 140 is capable of executing data instructions that cause the automatic control unit 102 to perform functions including the methods and operations disclosed herein.

The memory 142 is in data communication with the processor 140 and can store the data instructions that are executable by the processor 140. The memory 142 is an example of computer readable media. In some embodiments the memory 142 is part of the CPU, while in other embodiments it is separate. There may be multiple memory devices in some embodiments, and can be multiple different types of memory devices. An example of the memory 142 is system memory, such as read only memory and random access memory. The memory can also include a secondary storage device, such as a hard disc drive or solid state drive, for storing digital data. The digital data can include the data instructions, application programs, and/or program modules, and can also include status information or other data collected during the operation of the fire extinguishing system 100. For example, status information can be stored and timestamped for record keeping purposes to track when the system 100 is used, and what its operational state was while it was being used.

The memory 142 is computer readable storage media.

Computer readable media includes any available media that can be accessed by the processor 140. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, optical storage, magnetic disk storage or other magnetic storage devices, or any other medium that can be used to store the desired information and that can be accessed by the processor 140. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

In some embodiments the automated control unit 102 includes firmware and/or software. The firmware and/or software can be updated by providing the firmware and/or software updates on a device including at least a memory device (e.g., a chip), and connecting the device to transfer the firmware and/or software updates to the automated control unit 102. In some embodiments the automated control unit 102 includes a receptacle at the exterior of the housing into which the device can be connected. In other embodiments the front panel 170 of the automatic control unit 102 can be removed, and the device can be connected to a connector inside of the automatic control unit 102.

The sensor inputs 144 operate to receive status information from one or more monitoring devices, for use by the fire extinguishing system 100. The status information can include operational status information about the fire extinguishing system 100 itself, and also environmental conditions associated with the zones and protected regions. Examples of operational status information include a pressure of the agent dispenser 108, whether fire protection units 104 are connected and which ones, whether an agent dispenser has activated, and whether an error or malfunction is detected. Examples of environmental status information include a temperature within a protected region, whether the temperature within a protected region has exceeded a threshold temperature, whether a fire has been detected, whether a spark has been detected.

In another possible embodiment, at least some environmental status information can be determined based on the operational status information. For example, if the operational status information indicates a sudden loss of pressure at an agent dispenser 108, the system can determine that a fire has been detected and that the agent dispenser has activated. This could happen, for example, if a heat-sensitive line was used to automatically deploy fire extinguishing agent when a temperature exceeded a threshold value. Examples of the monitoring devices and associated sensors are described in further detail herein with reference to FIGS. 7 and 8.

The zone-specific outputs 146 generate and send control signals that can be sent to the fire protection units 104 to control the operation of the fire protection units 104 in each zone. One example of a zone-specific output is an activation instruction that can be sent to fire the protection units 104 individually or collectively. The activation instruction causes the fire protection unit 104 to activate the respective agent dispenser 108 to dispense fire extinguishing agent.

The audible output device 148 generates audible outputs. An example of the audible output device 148 is a speaker. Examples of audible outputs include an alarm to indicate that a fire has been detected, an alarm to indicate that a fire protection unit 104 has activated to dispense fire extinguishing agent, and an alert regarding a possible error or malfunction of the fire extinguishing system 100. Different audible sounds can be generated for different situations, from louder continuous alarms to softer intermittent chirps, for example.

The visible output device 150 generates visible outputs. In one example, the visible output device 150 includes at least one light source, such as an LED. In some embodiments, the visible output device 150 is an array of light emitting diodes (LEDs). Examples of visible outputs include bright and frequent flashing to indicate that a fire has been detected, flashing to indicate that a fire protection unit 104 has activated to dispense fire extinguishing agent, and dimmer and/or shorter and less frequent flashing to alert the operator to a possible error or malfunction of the fire extinguishing system 100. Different visible outputs can be generated for different situations, from brighter and more continuous output to softer and less frequent output, for example. In some embodiments the visible output device 150 generates red light, but other colors can be used in other embodiments. In some embodiments the visible output device includes multiple color LEDs, and different colors can be selected for different situations.

Some embodiments further include an auxiliary output 152. The auxiliary output can be connected to an auxiliary device, such as an external audible output device or visual output device. For example, if a particular application is likely to have the fire extinguishing system 100 operating when an operator is not in close proximity, the auxiliary output 152 can be connected to an external system to alert the operator. Examples of the external devices include an alarm, a horn, a light, and a wireless communication system (e.g., to send an alert to a smartphone or other remote computing device).

The power input 154 received power from an external source to power the fire extinguishing system 100 and automatic control unit 102. An example of the input power source is a 12V or 24V DC input voltage. The power input 154 can include a receptacle for receiving a cable plug, and the cable can be hard wired to an external power source or may also be plugged into a power source.

The power control 156 operates as an on/off control for the fire extinguishing system 100 and the automatic control unit 102. The power control can take various forms including switches and buttons. In one example the power control 156 is a button that is pressed to turn on the automatic control unit 102, and is pressed again to turn off the automatic control unit 102. Turning off the automatic control unit 102 also operates to reset the automatic control unit in some embodiments, such as to clear an error or malfunction code and recheck the operational status.

The manual activation control 158 is a selectable control that can be used to manually activate the agent dispensers 108 of the fire protection units 104 when the operator has detected a fire. The manual activation control 158 is configured to receive an input from the operator. The manual activation control 158 can be any suitable type of control, such as a switch or a button. In some embodiments the manual activation control 158 is a button that must be depressed for a period of time (e.g., 5 seconds) in order to activate the agent dispensers 108. In some embodiments all available agent dispensers 108 are activated when the manual activation control 158 is pressed. In other possible embodiments one or more fire protection units 104 in particular zones can be activated. In some embodiments a separate manual activation control 158 is provided for each fire protection unit 104 in each zone. After the input is received from the operator into the manual activation control 158, the automatic control unit activates the agent dispenser unit to dispense the fire extinguishing agent, such as by sending a signal to the agent dispenser 108, as discussed in further detail herein.

In some embodiments the automatic control unit 102 includes a circuit board on which at least some of the automatic control unit 102 components are mounted, such as the processor 140 and memory 142. The circuit board includes electrical conductors that carry electrical signals between the various components. The automatic control unit 102 can also include terminal blocks, wiring connectors, wires, and the like to connect the circuit board with components that are not mounted on the circuit board, such as components mounted on the front panel 170, as shown in FIG. 6.

FIG. 6 illustrates an example of a front panel 170 of the automatic control unit 102. In this example, the front panel 170 includes the audible output device 148, the visible output device 150, the power control 156, and the manual activation control 158, as described in further detail with reference to FIG. 5.

In some embodiments the automated control unit 102 generates anomaly alerts. The anomaly alerts can be generated based on the environmental status or on the operational status. In some embodiments, the anomaly alerts are visible codes (e.g., flashing codes displayed by flashing the light sources) that are output at the front panel 170 using one or more light sources. For example, in some embodiments, selectable controls on the front panel 170 can include one or more light sources of one or more colors. The light sources can be controlled by the automatic control unit 102 to generate the anomaly codes.

In a more specific example, the power control 156 and the manual activation control 158 both include light sources therein that can generate visible codes.

As one example, the power control 156 includes a first color code and a second color code, such as a green light and a red light. A steady green light output indicates that the automatic control unit 102 is on and is ready to respond to inputs. A steady red light output indicates that the automatic control unit is in a fault output shutdown mode, during which the automatic control unit 102 will not respond to inputs.

In some embodiments, the manual activation control 158 is utilized to provide more specific anomaly codes, including a first set of anomaly codes when the automatic control unit 102 is on and is ready to respond to inputs (e.g., the power control 156 is green), and a second set of anomaly codes when the automatic control unit 102 is in the fault output shutdown mode (e.g., the power control 156 is red).

An example of the first set of anomaly codes includes:
1 flash indicates that the zone 1 input is shorted during power on, typically indicative of a bad connection associated with the fire protection unit 104A in zone 1.
2 flashes indicates that the zone 2 input is shorted during power on, typically indicative of a bad connection associated with the fire protection unit 104B in zone 2.
3 flashes indicates that the zone 3 input is shorted during power on, typically indicative of a bad connection associated with the fire protection unit 104 in zone 3.
4 flashes indicates that the pressure gauge input is not detected, typically indicative of a bad connection associated with one or more of the zone monitoring systems 106 or the pressure gauges 224 (FIG. 8).
5 flashes indicates that the agent dispenser connection for zone 1 was not detected, typically indicative of a bad connection associated with the agent dispenser 108A or the actuator 226 (FIG. 8) in zone 1.
6 flashes indicates that the agent dispenser connection for zone 2 was not detected, typically indicative of a bad connection associated with the agent dispenser 108B or the actuator 226 (FIG. 8) in zone 2.
7 flashes indicates that the agent dispenser connection for zone 3 was not detected, typically indicative of a bad connection associated with the agent dispenser 108 or the actuator 226 (FIG. 8) in zone 3.
8 flashes indicates a system anomaly has been detected and that the system should be serviced.

More, fewer, or different codes can be provided in other embodiments. For example, more or fewer codes can be provided depending on the number of zones being protected by the system. Additionally, more or fewer sensor can be provided, with error codes being available for each sensor, or each type of sensor.

An example of the second set of anomaly codes includes:
1, 2 or 3 flashes indicates an internal communication error within the automated control unit. One possible source of this anomaly is the automatic control unit being placed near to a high power two-way radio antenna or other source of electrical interference. The problem may be rectified by moving the automatic control unit away from the source of electrical interference.
4 flashes indicates a problem with the (e.g., 12V) power input 154 (FIG. 5). This can be caused by an over current condition on the auxiliary output, an over temperature condition, or a power supply failure, for example.
5 flashes indicates a problem with the (e.g., 24V) power input 154 (FIG. 5). This can be caused by an over current condition on the auxiliary output, an over temperature condition, or a power supply failure, for example.
6 flashes indicates that an overcurrent condition has been detected at the (e.g., 24V) power input 154. This can be cause by an over current condition in the sensor inputs 144 (FIG. 5) or the zone-specific outputs 146 (FIG. 5), for example.
7 or 8 flashes indicates a system anomaly has been detected and that the system should be serviced.

In some embodiments the manual activation control 158 can be used to perform multiple functions. An additional function is to silence an audible output from the audible output device 148 by pressing the manual activation control 158 once while an alarm is activated. In some embodiments, once the manual activation control 158 is pressed once, the alarm stops but the audible output device 148 will continue to “chirp” every several seconds as a reminder that the alarm condition remains active. An additional function is to reduce a visible output from the visible output device 150. This can be accomplished by receiving two presses at the manual activation control 158. In some embodiments the visible output is then adjusted to a single flash every few seconds as a reminder that the alarm condition remains active.

The power control 156 can be pressed to turn off the automatic control unit 102 and stop all audible and visible alarms. Pressing the power control 156 again resets the automatic control unit 102, which then checks the sensor inputs 144 (FIG. 5) for any anomalies in the operational status inputs or the environmental status inputs, and if no anomalies are detected then no further alarms or alerts are provided.

FIG. 7 illustrates an example of a back panel 190 of the automatic control unit 102. In this example, the back panel 190 includes a receptacle 192, a receptacle 194, a receptacle 196, and a mount component 198. The example mount component includes a plate 200 and a ball 202.

In this example, the back panel 190 of the automatic control unit 102 includes electrical receptacles to which electrical wiring can be connected. In some embodiments the electrical wiring is configured as wiring harnesses with plugs at the ends. A plug at one end is configured to be inserted into the appropriate one of the receptacles. In this example each receptacle has a different size and shape so that each plug only fits into one of the receptacles. The receptacles include one or more pins that extend outward, and align with female contacts in the plugs to make an electrical contact between the automatic control unit 102 and the wiring harness, which in turn makes an electrical connection to a component connected to the opposite end of the wiring harness. Although three receptacles are shown in FIG. 7, more or fewer receptacles can be provided in other embodiments.

The example receptacle 192 is configured to receive power from an external source, and forms at least part of the power input 154 (shown in FIG. 5).

In some embodiments the receptacle 192 is also used to connect with the zone monitoring system 106 (FIG. 1) to provide sensor inputs including operational status inputs (shown in FIG. 5). As one example, the receptacle 192 receives operational status information relating to the operational status of the fire extinguishing system 100. An example of the operational status information is a pressure status of the agent dispensers 108. The pressure status can be detected by a pressure gauge associated with the agent dispenser, and can be provided as a pressure value, or can indicate whether the pressure has decreased below a threshold value.

In some embodiments the receptacle 192 is also used to connect the auxiliary output 152 (FIG. 5) to an auxiliary device, if an auxiliary device is desired for the particular application.

The example receptacle 194 is provided for connecting the automatic control unit 102 with one or more environmental sensors (e.g., of the zone monitoring systems 106, shown in FIG. 1), for monitoring the respective zones. In some embodiments the sensors provide environmental information, such as environmental data including temperature readings. Other environmental information can include whether a fire is detected, and whether a spark is detected, for example.

The example receptacle 196 is provided for connecting the automatic control unit 102 with the agent dispensers 108. The receptacle 196 is connected to the zone-specific outputs 146, which can control actuators of the agent dispensers 108 to cause the agent dispensers to dispense fire extinguishing agent.

In the illustrated example, the automatic control unit 102 further includes the mount component 198. The mount component 198 is used for mounting the automatic control unit at a convenient location and position. In this example the mount component includes a plate 200, which is secured to the back panel 190, and a ball 202 that is connected to and extends out from the plate 200. The mount component 198 can be connected to other mount components (such as a second mount component), such as a socket arm (which itself may be ultimately connected to a wall, floor, frame, or the like). The socket arm may include an adjustable tension control to open and close the socket to receive and engage the ball. Once the automatic control unit 102 is arranged at the desired location and position, the adjustable tension control is tightened to lock the automatic control unit 102 in place.

In some embodiments the automatic control unit 102 includes a compact housing 138 (FIG. 5). In some embodiments, the automatic control unit 102 has a width (e.g., as measured lengthwise across the front panel 170 or back panel 190) in a range from 4 inches to 12 inches, or in a range from 6 inches to 8 inches, or about 7.5 inches. In some embodiments, the automatic control unit 102 has a height (e.g., as measured from top to bottom across the front panel 170 or back panel 190) in a range from about 3 inches to about 8 inches, or from about 4 inches to about 5 inches, or about 4.5 inches. In some embodiments, the automatic control unit 102 has a depth (e.g., as measured as a distance from the front panel 170 to the back panel 180) in a range from 0.5 inches to about 5 inches, or from 2 inches to 3 inches, or about 2.5 inches. The compact size allows it to be easily and conveniently arranged within a cab or other location without taking up much space.

FIG. 8 is a schematic block diagram illustrating an example fire protection unit 104. In this example the fire protection unit 104 includes an agent container 220 including fire extinguishing agent 222, a pressure gauge 224, an actuator 226, one or more spray nozzles 228, and conduits 230.

The agent container 220 is a container configured to store the fire extinguishing agent 222. In some embodiments the agent container 220 stores the fire extinguishing agent in a pressurized state. A variety of different extinguishing agents can be used, such as water, wet chemical, and clean agents. For example, different agents are used for different classes of fires, such as fires on ordinary combustibles including wood, cloth, paper and plastics, fires on flammable liquids including gasoline, oil, grease and tar, or fires on energized electrical equipment including wiring, fuse boxes, circuit breakers and machinery. These and other agents can be used in various possible embodiments.

In some embodiments the agent container 220 is an aerosol spray can. The aerosol spray can includes, for example, a top that is crimped about its edges to form a permanent seal that prevents the agent from leaking from the agent container 220. The construction of the agent container 220 prevents leaking and allows it to last for a very long time without requiring frequent servicing, unlike traditional fire extinguishers that typically require annual servicing and have limited shelf lives.

In some embodiments the agent container 220 is a pre-pressurized agent container. In some embodiments the agent container 220 is a pre-pressurized aerosol agent container. Some embodiments of the agent container 220 utilize non-water fire extinguishing agents.

The agent container 220 has a limited capacity. If a greater capacity of fire extinguishing agent is desired within a particular zone, a plurality of agent containers 220 can be used. For example, a manifold can be used to connect a plurality of agent containers 220 together, with a single common output, such that the plurality of agent containers 220 can collectively provide a greater capacity of fire extinguishing agent for the particular application. As one example, the agent container has one or more of the following characteristics: a height in a range from 6 inches to 24 inches (e.g., about 12.5 inches), a diameter in a range from about 2 inches to about 6 inches (e.g., about 3 inches), an average burst strength in a range from about 600 psi to about 1200 psi (e.g., about 850 psi), and an amount of fire extinguishing agent in a range from about 800 grams to about 2,000 grams, or in a range from about 1000 to about 1750 grams.

The pressure gauge 224 is an example of a sensor of the zone monitoring system 106 (FIG. 1), which detects operational status information and provides it to the sensor inputs 144 (FIG. 5). The pressure gauge can measure the pressure of the agent 222 in the agent container 220 (in this example, through one or more conduits 230). The pressure gauge can measure the pressure and provide pressure data to the automatic control unit 102, or in another example, may monitor for the pressure to go below a threshold value and upon the occurrence of that event, send a signal to the automatic control unit. In one example the pressure threshold is in a range from about 30 psi to about 100 psi, or in a range from about 50 psi to about 70 psi, or 60 psi. In some embodiments a nominal pressure of a fully pressurized agent container 220 is in a range from about 90 psi to about 120 psi, or about 100 psi.

In some embodiments the pressure gauge is a 2-in-1 gauge, which includes both a visible pressure reading (such as through a pressure gauge dial display), and also provides an electronic signal indicative of the pressure, as discussed above. In some embodiments the pressure gauge 224 is connected to the agent container by a conduit and a fitting, such as a T-fitting, which allows the pressure gauge to detect the pressure of the agent 222 without interfering with the flow of agent when it is dispensed.

The actuator 226 controls the dispensing of agent 222 from the fire protection unit 104. In some embodiments, the actuator 226 is configured to receive a signal from the zone-specific outputs 146 of the automatic control unit 102 (FIG. 5), which instructs the actuator to dispense the fire extinguishing agent 222. An example of the actuator 226 is a solenoid valve, which is normally closed, but opens upon receipt of the signal from the automatic control unit 102.

One or more spray nozzles 228 are provided to spray the fire extinguishing agent 222 out from the fire protection unit. The nozzles are coupled to one or more conduits (such as flexible hoses), which can be arranged at any desired position in the zone, to spray the agent 222 onto the fire in the protected region (FIG. 1). For example, in some embodiments the fire protection unit 104 is largely arranged exterior to the protected region, but the conduit and nozzle extend into the protected region (e.g., through a hole in a wall). Any desired number of conduits 230 and nozzles 228 can be provided and used for dispensing agent 222. One or more fittings, a manifold, and/or conduits and the like can be used to connect a plurality of nozzles 228.

As shown in FIGS. 1 and 2, a single fire extinguishing system 100 can include multiple fire protection units 104 (e.g., one, two, three, four, five, or more).

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A fire extinguishing system comprising:
a fire protection unit comprising:
a monitoring system for monitoring an environmental status; and
an agent dispenser including an aerosol agent container storing aerosol fire extinguishing agent; and
an automatic control unit comprising a processor and a memory device, the memory device storing data instructions that, when executed by the processor cause the automatic control unit to:
receive the environmental status from the monitoring system; and
automatically activate the agent dispenser unit to dispense the fire extinguishing agent when the environmental status indicates the presence of a fire.

2. The fire extinguishing system of claim 1, wherein the monitoring system is a zone monitoring system that monitors the environmental status of a particular zone including a protected region.

3. The fire extinguishing system of claim 1, comprising a plurality of fire protection units, wherein each of the fire protection units is associated with a particular zone of a plurality of zones, including a particular protected region of a plurality of protected regions.

4. The fire extinguishing system of claim 3, wherein the automatic control unit individually monitors each of the zones for a fire, and individually activates a particular one of the fire protection units when the fire is detected in the zone associated with the particular one of the fire protection units.

5. The fire extinguishing system of claim 1, wherein the automatic control unit further comprises an output device, wherein the output device generates an alert when the fire has been detected.

6. The fire extinguishing system of claim 5, wherein the output device is an audible output device comprising a speaker.

7. The fire extinguishing system of claim 5, wherein the output device is a visible output device comprising a light source.

8. The fire extinguishing system of claim 5, wherein the output device is an auxiliary output device that is separate from the automatic control unit but controllable by the automatic control unit to generate the alert.

9. The fire extinguishing system of claim 8, wherein the auxiliary output device is a wireless communication device that wirelessly transmits the alert to a remote computing device.

10. The fire extinguishing system of claim 1, wherein the monitoring system further monitors an operational status of the fire protection unit.

11. The fire extinguishing system of claim 10, wherein the operational status includes a pressure of the aerosol agent container.

12. The fire extinguishing system of claim 1, wherein the automatic control unit is further configured to output at least one anomaly alert, wherein the anomaly alert is based on at least one of an operational status or an environmental status.

13. The fire extinguishing system of claim 12, wherein the anomaly alert is a flashing code, wherein the flashing code identifies a particular type of anomaly.

14. The fire extinguishing system of claim 1, wherein the agent dispenser further comprises a solenoid valve, wherein when the automatic control unit automatically activates the agent dispenser, the automatic control unit sends a signal that opens the solenoid valve allowing the fire extinguishing agent to flow from the aerosol agent container and to be dispensed through a nozzle.

15. The fire extinguishing system of claim 1, wherein the automatic control unit further comprises a manual activation control, wherein the manual activation control is configured to receive an input from an operator, and to activate the agent dispenser unit to dispense the fire extinguishing agent after the input is received.

16. The fire extinguishing system of claim 1, wherein the automatic control unit further comprises a mount component connected to a back panel of the automatic control unit housing, the mount component usable to secure and support the automatic control at a desired location and in an adjustable position.

17. The fire extinguishing system of claim 1, wherein the mount component comprises a plate connected to the back panel, and a ball extending from the plate.

18. The fire extinguishing system of claim 17, further comprising a second mount component comprising an adjustable socket arm, wherein the adjustable socket arm includes a ball socket configured to receive the ball and to support the automatic control unit in the adjustable position.

19. An automatic control unit for a fire extinguishing system, the automatic control unit comprising:
a processing device; and
a memory device storing data instructions that, when executed by the processor cause the automatic control unit to:
receive an environmental status from a monitoring system; and
automatically activate an agent dispenser unit to dispense an aerosol fire extinguishing agent when the environmental status indicates the presence of a fire.

20. A method of extinguishing a fire, the method comprising:
receiving an environmental status of a protected region at an automatic control unit of a fire extinguishing system;
determining that a fire is in the protected region using a processing device of the automatic control unit based on the environmental status; and
automatically activating the agent dispense unit from the automatic control unit to cause the agent dispense unit to dispense fire extinguishing agent from a pre-pressurized agent container.
